(19) United States
(12) Patent Application Publication
(10) Pub. No.: US 2025/0326385 A1
(43) Pub. Date: Oct. 23, 2025

(54) ELECTROMECHANICAL BRAKE BOOSTER FOR A BRAKING SYSTEM OF A VEHICLE

(71) Applicant: Robert Bosch GmbH, Stuttgart (DE)

(72) Inventors: Sebastian Bauer, Bad Wimpfen (DE); Willi Nagel, Remseck/Hochdorf (DE)

(21) Appl. No.: 18/866,430

(22) PCT Filed: May 22, 2023
(86) PCT No.: PCT/EP2023/063607

§ 371 Date: Nov. 15, 2024

(30) Foreign Application Priority Data
May 30, 2022 (DE) 10 2022 205 425.3

(51) Int. Cl. B60T 11/18; B60T 13/74

(52) U.S. Cl. CPC B60T 11/18; B60T 13/746

(57) ABSTRACT

An electromechanical brake booster for a braking system of a vehicle. The electromechanical brake booster includes: an electric motor; at least one linearly movable piston component; a transmission device via which the electric motor is connected to the piston component so that a motor force of the electric motor can be transmitted to the piston component via the transmission device; a transmission housing component which at least partially surrounds the transmission device; at least one connecting rod to which the linearly movable piston component is connected in such a way that the piston component, which is linearly moved via the transmitted motor force, is guided via the connecting rod; an intermediate plate, which is produced as a component which is separate from the transmission housing component, wherein the connecting rod is fastened to the intermediate plate, and the intermediate plate is fastened to the transmission housing component.

### FIELD

The present invention relates to an electromechanical brake booster for a braking system of a vehicle. The present invention also relates to a braking system for a vehicle. Furthermore, the present invention relates to a production method for an electromechanical brake booster for a braking system of a vehicle.

### BACKGROUND INFORMATION

Electromechanical brake boosters are described in the related art, such as in Germany Patent Application No. DE 10 2018 211 549 A1, and in each case have an electric motor, a transmission device and a linearly movable piston component, which is movable by means of a motor force of the electric motor that is transmitted via the transmission device. Such an electromechanical brake booster usually also comprises a transmission housing component of the transmission device and at least one connecting rod by means of which the linearly movable piston component is guided.

### SUMMARY

The present invention provides an electromechanical brake booster for a braking system of a vehicle, a braking system for a vehicle, and a production method for an electromechanical brake booster for a braking system of a vehicle.

An example embodiment of the present invention provides electromechanical brake boosters which, on account of each one being equipped with an intermediate plate, dispense with the conventional need for fastening the at least one connecting rod to a housing base of the transmission housing component. By introducing the intermediate plate into an electromechanical brake booster according to the present invention, a position of the at least one connecting rod in relation to a vehicle wall, to which the electromechanical brake booster is fastened by means of at least one screw attached to the housing base of the transmission housing component, is decoupled. The decoupling of the position of the at least one connecting rod in relation to the vehicle wall brought about by means of the present invention allows a position of the electromechanical brake booster according to the present invention to be selected with an alignment freedom of (almost) 360° (degrees) depending on the availability of an installation space used for attaching the electromechanical brake booster to the vehicle wall. As will additionally become clear from the following description, introducing the intermediate plate into the electromechanical brake booster according to the present invention greatly reduces a component variance of its transmission housing component that is required to equip a large number of different (motor) vehicle types with the electromechanical brake booster. Furthermore, if the electromechanical brake booster according to the present invention is equipped with exactly two connecting rods fastened to the intermediate plate, a symmetrical arrangement of the electric motor with respect to the two connecting rods is possible.

In an advantageous example embodiment of the electromechanical brake booster of the present invention, at least part of the intermediate plate forms a motor bearing shield of the electric motor. The intermediate plate can therefore also be used to integrate the functions of the motor bearing shield. Owing to this multifunctionality of the intermediate plate, the embodiment described here of the electromechanical brake booster does not need to be equipped with an “additional motor bearing shield.”

For example, the intermediate plate can be fastened to the transmission housing component by means of at least one rivet connection, at least one screw connection, at least one weld connection, and/or at least one clinch connection. A large number of securing techniques that are easy and cost-effective to implement can thus be used to fasten the intermediate plate to the transmission housing component.

According to an example embodiment of the present invention, preferably, at least one screw is fastened to a side of a housing base of the transmission housing component that faces away from the intermediate plate, by means of which screw the electromechanical brake booster can be fastened or is fastened to a vehicle wall. Since, due to the electromechanical brake booster being additionally equipped with its intermediate plate, a position of the at least one connecting rod is decoupled from at least one fastening opening punched through the housing base for the at least one screw, it is possible to dispense with a conventional need to adapt, in relation to the desired position of the at least one connecting rod, a punching press used to create the at least one fastening opening for the at least one screw. This reduces the production costs for the transmission housing component with the at least one screw and saves conventional downtimes during its production.

In a further advantageous example embodiment of the electromechanical brake booster of the present invention, a first connecting rod and a second connecting rod are fastened as the at least one connecting rod to the intermediate plate, wherein the first connecting rod and the second connecting rod extend in parallel with each other at a maximum spacing of less than or equal to 80 mm. By virtue of fastening, according to the present invention, the two connecting rods to the transmission housing component, the connecting rods can be arranged closer together. The electromechanical brake booster can therefore be equipped with its intermediate plate to save installation space.

If an end of the at least one connecting rod that faces away from the intermediate plate is fastened to a flange of a brake master cylinder, the flange of the brake master cylinder can have a maximum diameter of less than or equal to 80 mm in a spatial direction oriented perpendicularly to the at least one connecting rod. This can be used to save material on a brake master cylinder housing, formed with the flange, of the brake master cylinder.

According to an example embodiment of the present invention, preferably, a motor housing at least partially surrounding the electric motor is fastened to the intermediate plate. The intermediate plate can therefore also be used to fasten the motor housing.

In a further advantageous example embodiment of the electromechanical brake booster of the present invention, a cover at least partially surrounding the at least one linearly movable piston component and the at least one connecting rod is fastened to the intermediate plate, wherein the cover has a maximum diameter of less than or equal to 100 mm in the spatial direction oriented perpendicularly to the at least one connecting rod. Since advantageously equipping the electromechanical brake booster described here with its intermediate plate makes possible a smaller spacing between multiple connecting rods, and thus also the use of the cover with a reduced diameter in comparison to the related art, installation space can be saved in the embodiment described here of the electromechanical brake booster.

The advantages described above are also ensured in a braking system for a vehicle having such an electromechanical brake booster. The braking system may, for example, be a brake-by-wire braking system or a servo braking system.

Furthermore, carrying out a corresponding production method for an electromechanical brake booster for a braking system of a vehicle also provides the advantages explained above. It is expressly pointed out that the production method can be developed according to the above-described embodiments of the electromechanical brake booster.

### BRIEF DESCRIPTION OF THE DRAWINGS

Further features and advantages of the present invention will be explained in the following with reference to the figures.

FIG. 1A to 1D show schematic representations of a first example embodiment of the electromechanical brake booster of the present invention.

FIG. 2A and 2B show schematic representations of a second example embodiment of the electromechanical brake booster of the present invention.

FIG. 3 shows a flowchart for explaining an example embodiment of the production method for an electromechanical brake booster for a braking system of a vehicle, according to the present invention.

### DETAILED DESCRIPTION OF EXAMPLE EMBODIMENTS

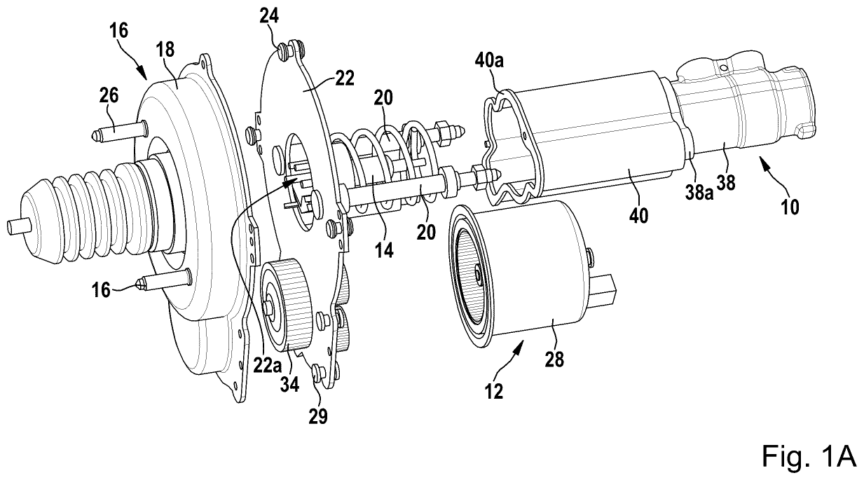

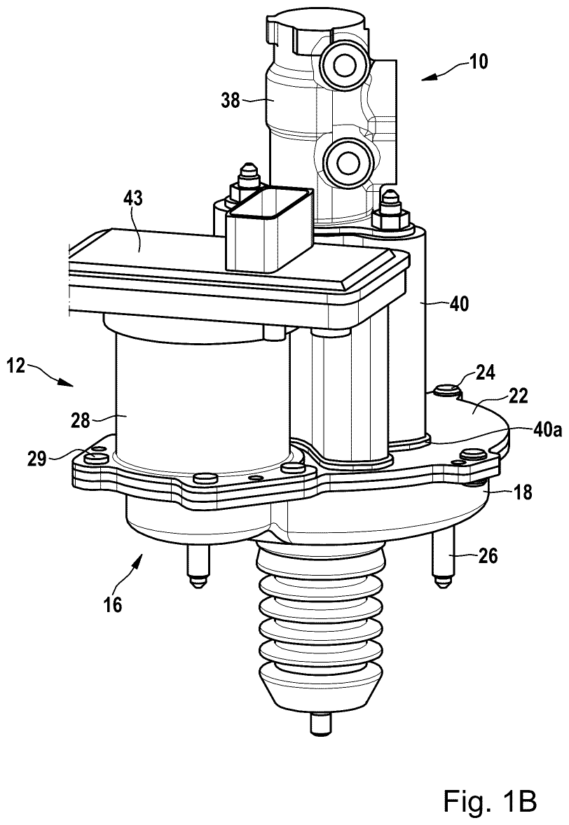

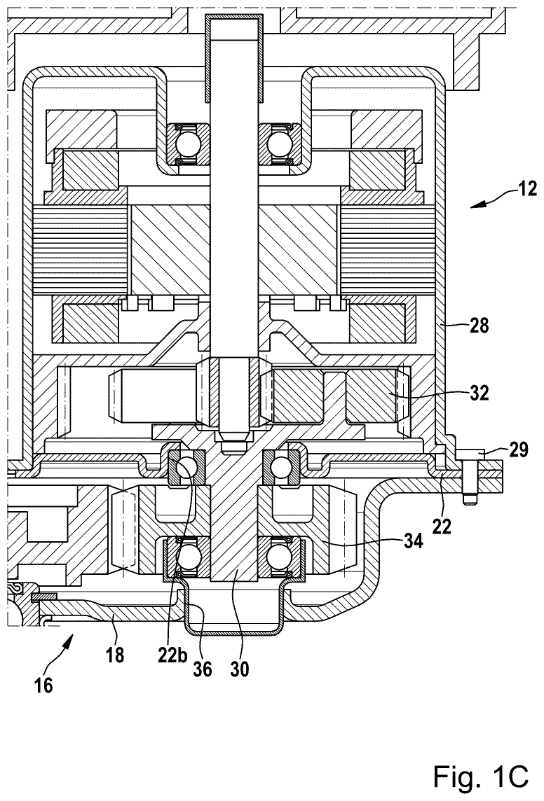

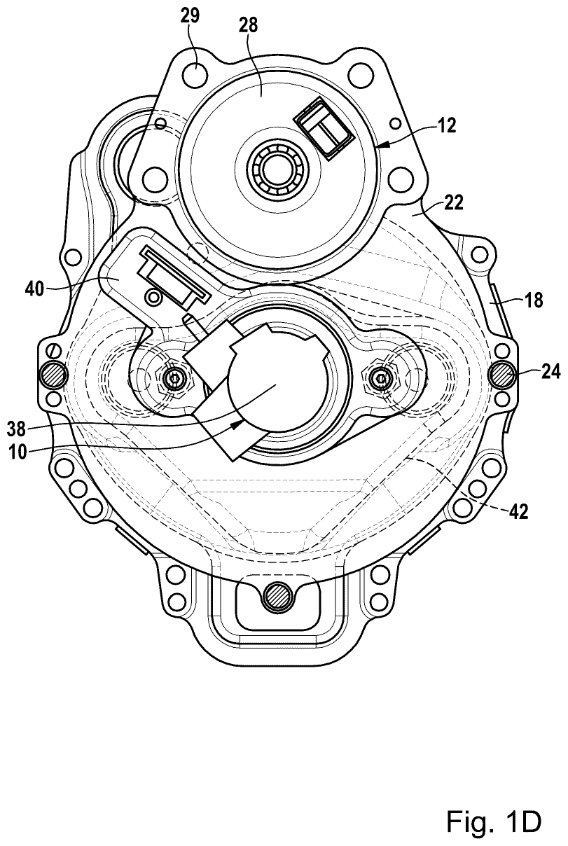

FIG. 1A to 1D are schematic representations of a first embodiment of the electromechanical brake booster.

The electromechanical brake booster shown schematically in FIG. 1A to 1D can be used in a braking system of a (motor) vehicle. The braking system may, for example, be a servo braking system, in which a brake actuating element (not shown), such as a brake pedal, is mechanically connected to the electromechanical brake booster such that a driver's braking force exerted on the brake actuating element can be “introduced” into a brake master cylinder 10 in such a way that a brake pressure build-up in the brake master cylinder 10 can be brought about by means of the driver's braking force. In this case, an electric motor 12 of the electromechanical brake booster can be used to increase, by means of its motor force, the brake pressure build-up brought about in the brake master cylinder 10 by means of the driver's braking force; this assists the driver in terms of force when the driver brakes the (motor) vehicle equipped with the servo braking system. Alternatively, the braking system may also be a brake-by-wire braking system, in which the driver uses the driver's braking force merely to brake into a simulator, while a brake pressure build-up in the brake master cylinder 10 is brought about exclusively by means of the motor force of the electric motor 12 of the electromechanical brake booster. A basic type of the electromechanical brake booster described here can be adapted in a simple manner either to the servo braking system or to the brake-by-wire braking system by easily converting only a few components of the electromechanical brake booster. The general structure of the electromechanical brake booster described below as well as its production process and an assembly process to be carried out for mounting the electromechanical brake booster on the (motor) vehicle remain (virtually) unaffected by the subsequent use of the electromechanical brake booster either for a servo braking system or for a brake-by-wire braking system.

The brake master cylinder 10 can be understood as either a brake master cylinder 10 of the electromechanical brake booster or a brake master cylinder 10 fastened to the electromechanical brake booster as a component produced separately therefrom. It should also be noted that the usability of the electromechanical brake booster is not limited to any specific type of (motor) vehicle subsequently equipped therewith.

In addition to its electric motor 12, the electromechanical brake booster has at least one linearly movable piston component 14, such as a valve body. In addition, the electromechanical brake booster has a transmission device 16 via which the electric motor 12 is connected to the at least one linearly movable piston component 14 in such a way that, when the electric motor 12 is operated, the motor force of the electric motor 12 is or can be transmitted to the at least one linearly movable piston component 14 via the transmission device 16. The piston component 14 is linearly movable toward the brake master cylinder 10, in particular by means of the transmitted motor force of the electric motor 12, in such a way that a brake pressure build-up in the brake master cylinder 10 is or can be brought about by means of the linearly moved piston component 14.

As can be seen in FIG. 1A, a transmission housing component 18 at least partially surrounds the transmission device 16. FIG. 1A also shows at least one connecting rod 20 to which the at least one linearly movable piston component 14 is connected in such a way that the piston component 14, which is linearly moved by means of the transmitted motor force, is guided by means of the at least one connecting rod 20. The at least one connecting rod 20 may also be understood as a tension rod in each case. The electromechanical brake booster of FIG. 1A to 1D also has an intermediate plate 22, to which the at least one connecting rod 20 is fastened. In addition, the intermediate plate 22 is fastened to the transmission housing component 18. Thus, there is mechanical contact both between the at least one connecting rod 20 and the intermediate plate 22 and between the intermediate plate 22 and the transmission housing component 18. However, it is pointed out that the intermediate plate 22 is to be understood as a component produced separately from the transmission housing component 18.

Fastening the at least one connecting rod 20 to the intermediate plate 22 dispenses with the conventional need for directly fastening the at least one connecting rod 20 to a housing base of the transmission housing component 18, i.e., for fastening the at least one connecting rod 20 in mechanical contact with the housing base of the transmission housing component 18. The transmission housing component 18 can therefore be produced without punching at least one connecting rod opening for fastening the at least one connecting rod 20 to the housing base of the transmission housing component. While the related art still requires punching at least one connecting rod opening into the transmission housing component 18 by means of a punching press, this requirement is dispensed with in the electromechanical brake booster of FIG. 1A to 1D. This is advantageous since the transmission housing component 18 is arranged in different orientations depending on the available installation space when mounting the electromechanical brake booster on different vehicle types. (The orientation of the transmission housing component 18 that is selected for mounting the electromechanical brake booster is generally determined by the availability of sufficient installation space for the electric motor 12.) By eliminating the conventional need to punch the at least one connecting rod opening for fastening the at least one connecting rod 20 to the transmission housing component 18, it is also possible to dispense with the conventional need to convert the punching press used for this purpose according to the type of vehicle subsequently equipped with the electromechanical brake booster and to eliminate downtime required for this purpose of the tools used in production. Furthermore, component variances of the transmission housing component 18 that are required in the related art are eliminated, for example a plurality of part families with geometrically different variances. Eliminating the conventionally required “mirror”/“non-mirror” part variance also contributes to reducing the component variance of the transmission housing component 18 of the electromechanical brake booster described here. Reducing the component variance also allows the process variance in the production line to be reduced. By eliminating tool downtimes that would normally occur, the production line can also be utilized more efficiently. Since the number of tool changes on the production line is also significantly reduced, the tools can also be made less complex and therefore more cost-effective. Costs that typically arise for variant management are also eliminated.

Furthermore, by reducing the component variance, the complexity of the production line can be reduced, which has a positive affect both on the service life thereof and on the initial investment in the production line. The advantages described here all contribute to cost savings in the production of the transmission housing component 18, in comparison to which the “additional costs” of the intermediate plate 22 are negligible.

For example, the intermediate plate 22 may be fastened to the transmission housing component 18 by means of at least one rivet connection 24, at least one screw connection, at least one weld connection, and/or at least one clinch connection. In this way, a number of easily formed and secure connection types can be used to fasten the intermediate plate 22 to the transmission housing component 18. The intermediate plate 22 may have a flat/planar shape. However, it should be noted that the shape of the intermediate plate 22 shown in FIG. 1A is to be interpreted as a flat/planar plate only by way of example. A planar extension of the intermediate plate 22 may be so large that the intermediate plate 22 fastened to the transmission housing component 18 completely covers a recess/receiving opening of the transmission device 16 that is formed in the transmission housing component 18. For example, the intermediate plate 22 may also be formed with a central opening 22a so that the motor force of the electric motor 12 can be transmitted to the at least one linearly movable piston component 14 via at least one component of the transmission device 16, said component projecting through the central opening 22a in the intermediate plate 22. Optionally, the driver's braking force may also be transmitted toward the brake master cylinder 10 via a force transmission component, such as an input rod, which projects through the central opening 22a in the intermediate plate 22.

FIG. 1B shows the electromechanical brake booster after assembly of its components, which are shown separately in FIG. 1A. It can be seen that the electromechanical brake booster has at least one screw 26, which is fastened to a side of the housing base of the transmission housing component 18 that faces away from the intermediate plate 22. The at least one screw 26 may be a stud, for example. The at least one screw 26 can be used to fasten the electromechanical brake booster to a vehicle wall (not shown) of the (motor) vehicle when said brake booster is mounted on the (motor) vehicle to be provided therewith. The position of the at least one fastening opening punched through the housing base of the transmission housing component 18 for the at least one screw 26 can be selected relatively freely.

As can also be seen in FIG. 1B, a motor housing 28 at least partially surrounding the electric motor 12 may be fastened to the intermediate plate 22. For example, the motor housing 28 may be fastened to the intermediate plate 18, preferably on a side of the intermediate plate 18 that faces away from the transmission housing component 18, by means of at least one rivet connection 29, at least one screw connection, at least one weld connection, and/or at least one clinch connection.

FIG. 1C shows a cross section through part of the electromechanical brake booster of FIG. 1B. As can be seen in FIG. 1C, at least part of the intermediate plate 22 can form a motor bearing shield/A-bearing shield of the electric motor 12. The functions of a motor bearing shield/A-bearing shield designed as a separate component can thus be ensured by the intermediate plate 22. By using the intermediate plate 22, a motor bearing shield/A-bearing shield, which is conventionally in the form of a separate component, can therefore be omitted (without replacement). As can be seen in FIG. 1C, a continuous further opening 22b extending through the intermediate plate 22 can be formed in the intermediate plate 22, through which opening a planet carrier 30 projects. A planetary gear 32 arranged in the motor housing 28 can be arranged on the planet carrier 30, while a drive gear 34 of the planet carrier 30 is located on a side of the intermediate plate 22 that faces away from the planetary gear 32. The drive gear 34 can also be arranged on the housing base of the transmission housing component 18 by means of a bearing carrier 36. However, the components 30 to 36 shown in FIG. 1C are to be interpreted only as examples.

The electromechanical brake booster shown schematically in FIG. 1A to 1D has, as its at least one connecting rod 20, exactly two connecting rods 20, which are fastened to the intermediate plate 22. On account of the two connecting rods 20 being fastened to the intermediate plate 22, there is no need to maintain a minimum spacing of at least 100 mm (millimeters) between the two connecting rods 20, which is conventionally necessary in the case of connecting rods fastened to the housing base of the transmission housing component 18. A maximum spacing between the two connecting rods 20 can therefore be less than 100 mm (millimeters). For example, the two connecting rods 20 of the electromechanical brake booster described here can extend in parallel with one another at a maximum spacing of less than or equal to 80 mm (millimeters), more particularly at a maximum spacing of less than or equal to 75 mm (millimeters), in particular at a maximum spacing of less than or equal to 70 mm (millimeters).

As will become clear from the following description, the reduction of the maximum spacing between the two connecting rods 20 can be utilized to reduce an installation space required for the electromechanical brake booster provided therewith:

The reduction of the maximum spacing between the two connecting rods 20 of the electromechanical brake booster can be utilized, for example, to reduce the size of a brake master cylinder housing 38 of the brake master cylinder 10. Specifically, it is possible to reduce the size of a flange 38a of the brake master cylinder housing 38 of the brake master cylinder 10, to which an end of each connecting rod 20 that faces away from the intermediate plate 22 is fastened. For example, the brake master cylinder 10 of the electromechanical brake booster may be designed such that its brake master cylinder housing 38 has a flange 38a with a maximum diameter of less than or equal to 80 mm (millimeters) in a spatial direction oriented perpendicularly to the connecting rods 20, such as a maximum diameter of less than or equal to 75 mm (millimeters), more particularly a maximum diameter of less than or equal to 70 mm (millimeters). The associated material savings on the brake master cylinder housing 38 reduces the production costs thereof and facilitates assembly of the brake master cylinder 10. Since a maximum extension of the flange 38a of the brake master cylinder housing 38 perpendicular to the connecting rods 20 is (substantially) predetermined by the maximum spacing between the connecting rods 20, the reduction in the maximum diameter of the flange 38a of the brake master cylinder housing 38 made possible by the advantageous reduction in the maximum spacing between the connecting rods 20 is not associated with any disadvantages.

FIG. 1A to 1D also show a cover 40 which at least partially surrounds the at least one linearly movable piston component 14 and the connecting rods 20 and is fastened to the intermediate 13 Substitute Specification plate 22. Due to the reduction of the maximum spacing between the connecting rods 20, the cover 40 can also be made smaller. In particular, the cover 40 can have a maximum diameter of less than or equal to 100 mm (millimeters) in a spatial direction oriented perpendicularly to the connecting rods 20, such as a maximum diameter of less than or equal to 90 mm (millimeters), in particular a maximum diameter of less than or equal to 80 mm (millimeters). An unused dead volume, which conventionally often occurs within an encasement 42 that at least partially surrounds the at least one linearly movable piston component 14 and the connecting rods 20, is thus eliminated in the cover 40. Instead, the design of the cover 40 for the electromechanical brake booster described here can be optimized such that there is (almost) no unused dead volume within the cover 40. This leads to further installation-space savings on the electromechanical brake booster. At the same time, less material can be used for the cover 40, with the result that the production costs thereof are reduced. Optionally, the cover 40 can be formed with a seal 40a, which seals an intermediate gap between the cover 40 and the intermediate plate 22 in a liquid-tight manner.

For comparison, FIG. 1D shows the encasement 42 of a conventional electromechanical brake booster, which encasement at least partially surrounds the at least one linearly movable piston component and the connecting rods of said brake booster. The encasement 42 of the conventional electromechanical brake booster is projected onto the cover 40 of the electromechanical brake booster of FIG. 1A to 1D. It can be seen from the comparison that the installation space required by the electromechanical brake booster of FIG. 1A to 1D is also significantly reduced by means of the advantageous reduction in size of its cover 40. In addition, the reduction in size of the cover 40 makes it easier to arrange control electronics 43 on a side of the motor housing 28 that faces away from the intermediate plate 22.

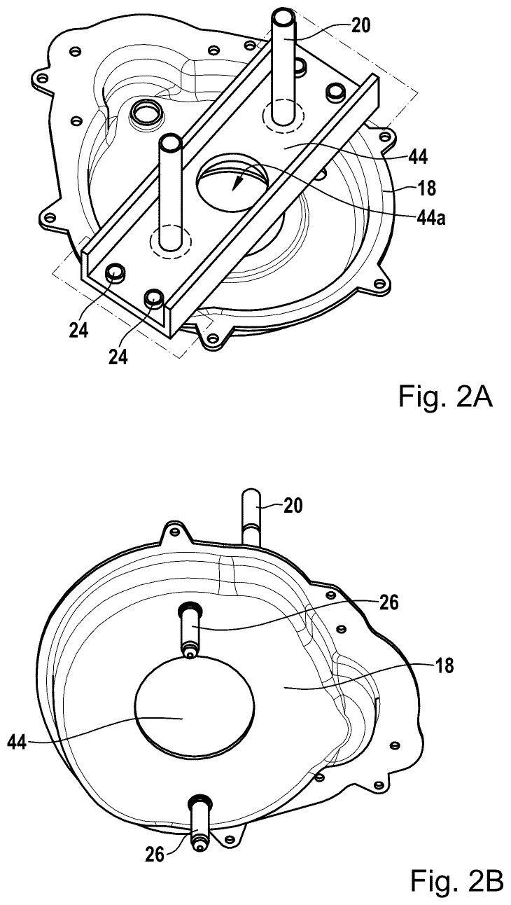

FIG. 2A and 2B show schematic representations of a second embodiment of the electromechanical brake booster.

In the electromechanical brake booster of FIG. 2A and 2B, the intermediate plate 44 is in the form of a U-profile (carrier) 44. The U-profile 44 is smaller and more flexurally rigid than the intermediate plate 22 of the above-described embodiment. A recess/receiving opening of the transmission device 16 that is formed in the transmission housing component 18 is covered only partially by the U-profile 44 fastened to the transmission housing component 18. A central opening 44a can also be formed in the U-profile 44 in such a way that the motor force of the electric motor 12 can be transmitted to the at least one linearly movable piston component 14 via at least one component of the transmission device 16, said component projecting through the central opening 44a, and the driver's braking force can possibly also be transmitted toward the brake master cylinder 10 via a force transmission component which projects through the central opening 44a.

The cover 40 (not shown) is preferably designed in such a way that the cover 40 projects beyond the U-profile 44, i.e., such that the U-profile 44 is located within a volume framed by the cover 40. This eliminates the need for a seal between the cover 40 and the U-profile 44.

With regard to further properties and features of the electromechanical brake booster shown schematically in part in FIG. 2A and 2B and its advantages, reference is made to the explanations of the embodiment of FIG. 1A to 1D.

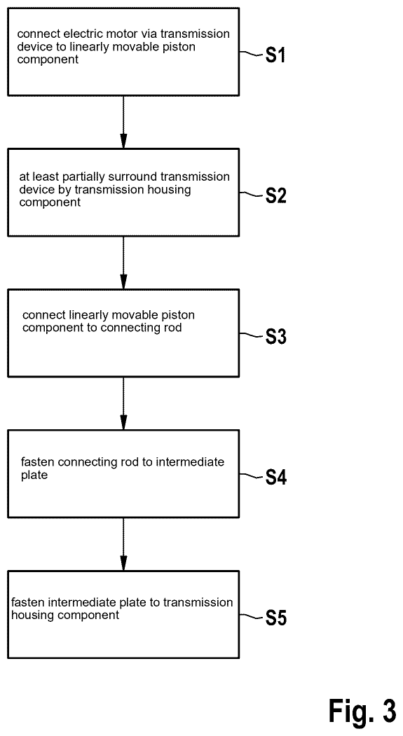

FIG. 3 is a flowchart for explaining an embodiment of the production method for an electromechanical brake booster for a braking system of a vehicle.

All of the electromechanical brake boosters described above can be produced by carrying out the production method described below. However, it is pointed out that the ability to carry out the production method is not limited to the production of the above-explained electromechanical brake booster.

In a method step S1 of the production method, an electric motor of the subsequent electromechanical brake booster is connected via a transmission device to at least one linearly movable piston component of the subsequent electromechanical brake booster in such a way that, when the electric motor is subsequently operated, a motor force of the electric motor is transmitted to the at least one linearly movable piston component via the transmission device. In a method step S2, the transmission device is at least partially surrounded by a transmission housing component. Furthermore, in a method step S3, the at least one linearly movable piston component is connected to at least one connecting rod in such a way that the piston component, which is linearly moved at least by means of the transmitted motor force, is guided by means of the at least one connecting rod.

The production method also comprises method steps S4 and S5. In method step S4, the at least one connecting rod is fastened to an intermediate plate, which is produced as a component which is separate from the transmission housing component. In addition, the intermediate plate is fastened to the transmission housing component in method step S5. By carrying out method steps S4 and S5, the advantages already explained above are achieved. Method steps S1 to S5 can be carried out in any order, simultaneously or in a manner overlapping in time.

1-10. (canceled)

11. An electromechanical brake booster for a braking system of a vehicle, comprising:
an electric motor;
at least one linearly movable piston component;
a transmission device via which the electric motor is connected to the at least one linearly movable piston component in such a way that, when the electric motor is operated, a motor force of the electric motor can be transmitted to the at least one linearly movable piston component via the transmission device;
a transmission housing component which at least partially surrounds the transmission device; and
at least one connecting rod to which the at least one linearly movable piston component is connected in such a way that the piston component, which is linearly moved using the transmitted motor force, is guided by the at least one connecting rod;
an intermediate plate, which is produced as a component which is separate from the transmission housing component, the at least one connecting rod being fastened to the intermediate plate, and the intermediate plate being fastened to the transmission housing component.

12. The electromechanical brake booster according to claim 11, wherein at least part of the intermediate plate forms a motor bearing shield of the electric motor.

13. The electromechanical brake booster according to claim 11, wherein the intermediate plate is fastened to the transmission housing component by at least one rivet connection and/or at least one screw connection and/or at least one weld connection and/or at least one clinch connection.

14. The electromechanical brake booster according to claim 11, wherein at least one screw is fastened to a side of a housing base of the transmission housing component that faces away from the intermediate plate, by means of which screw the electromechanical brake booster can be fastened or is fastened to a vehicle wall.

15. The electromechanical brake booster according to claim 11, wherein a first connecting rod and a second connecting rod are fastened as the at least one connecting rod to the intermediate plate, and wherein the first connecting rod and the second connecting rod extend in parallel with one another at a maximum spacing of less than or equal to 80 mm.

16. The electromechanical brake booster according to claim 11, wherein an end of the at least one connecting rod that faces away from the intermediate plate is fastened to a flange of a brake master cylinder, and wherein the flange of the brake master cylinder has a maximum diameter of less than or equal to 80 mm in a spatial direction oriented perpendicularly to the at least one connecting rod.

17. The electromechanical brake booster according to claim 11, wherein a motor housing at least partially surrounding the electric motor is fastened to the intermediate plate.

18. The electromechanical brake booster according to claim 11, wherein a cover at least partially surrounding the at least one linearly movable piston component and the at least one connecting rod is fastened to the intermediate plate, and wherein the cover has a maximum diameter of less than or equal to 100 mm in a spatial direction oriented perpendicularly to the at least one connecting rod.

19. A braking system for a vehicle, comprising:
an electromechanical brake booster including:
an electric motor,
at least one linearly movable piston component,
a transmission device via which the electric motor is connected to the at least one linearly movable piston component in such a way that, when the electric motor is operated, a motor force of the electric motor can be transmitted to the at least one linearly movable piston component via the transmission device,
a transmission housing component which at least partially surrounds the transmission device, and
at least one connecting rod to which the at least one linearly movable piston component is connected in such a way that the piston component, which is linearly moved by means of the transmitted motor force, is guided by means of the at least one connecting rod,
an intermediate plate, which is produced as a component which is separate from the transmission housing component, the at least one connecting rod being fastened to the intermediate plate, and the intermediate plate being fastened to the transmission housing component;
wherein the braking system is a brake-by-wire braking system or a servo braking system.

20. A production method for an electromechanical brake booster for a braking system of a vehicle, comprising the following steps:
connecting an electric motor of a subsequent electromechanical brake booster via a transmission device to at least one linearly movable piston component of the subsequent electromechanical brake booster in such a way that, when the electric motor is subsequently operated, a motor force of the electric motor is transmitted to the at least one linearly movable piston component via the transmission device;
at least partially surrounding the transmission device with a transmission housing component;
connecting the at least one linearly movable piston component to at least one connecting rod in such a way that the piston component, which is linearly moved at least using the transmitted motor force, is guided by the at least one connecting rod;
fastening the at least one connecting rod to an intermediate plate, which is produced as a component which is separate from the transmission housing component; and
fastening the intermediate plate to the transmission housing component.
